(19) United States
(12) Patent Application Publication
(10) Pub. No.: US 2022/0105922 A1
(43) Pub. Date: Apr. 7, 2022

(54) SYSTEM FOR PROVIDING AND/OR MONITORING OPERATING DATA OF A COMPRESSED AIR SUPPLY, COMPRESSED AIR SUPPLY, AND METHOD FOR PROVIDING OPERATING DATA AND/OR FOR MONITORING THE FUNCTIONALITY OF A COMPRESSED AIR SUPPLY

(71) Applicant: KNORR-BREMSE SYSTEME FÜR SCHIENENFAHRZEUGE GMBH, Munich (DE)

(72) Inventors: Thomas MERKEL, Hürth (DE); Sebastian REHBERGER, Munich (DE); Marc-Oliver HERDEN, Munich (DE)

(21) Appl. No.: 17/599,513

(22) PCT Filed: Feb. 28, 2020
(86) PCT No.: PCT/EP2020/055304

§ 371 Date: Sep. 28, 2021

(30) Foreign Application Priority Data
Mar. 28, 2019 (DE) 10 2019 108 066.5

(51) Int. Cl. B60T 17/22; B60T 13/26; B60T 8/17; B60T 8/174; B60T 8/171

(52) U.S. Cl. CPC B60T 17/228; B60T 13/26; B60T 8/171; B60T 8/174; B60T 8/1705

(57) ABSTRACT

A system for providing and/or monitoring operating data of a compressed air supply in a rail vehicle includes a detector for detecting the operating data, a communication device for wirelessly transmitting the detected operating data, and an external memory device for receiving and saving the detected operating data from the communication device.

### CROSS REFERENCE AND PRIORITY CLAIM

This patent application is a U.S. National Phase of International Patent Application No. PCT/EP2020/055304 filed Feb. 28, 2020, which claims priority to German Patent Application No. 10 2019 108 066.5, the disclosure of which being incorporated herein by reference in their entireties.

### FIELD

The disclosed embodiments relate to a system for providing and/or monitoring operating data of a compressed air supply in a rail vehicle. The disclosed embodiments further relate to a compressed air supply for generating compressed air for a rail vehicle. The disclosed embodiments further relate to a method for providing operating data and/or for monitoring the functionality of a compressed air supply in a rail vehicle.

### BACKGROUND

Compressed air supplies or compressed air systems in rail vehicles generally serve to provide compressed air in a defined quantity and quality, for example for actuating the brakes, opening and closing the doors and for controlling the air suspension. Compressed air supplies comprise a plurality of components, for example, a compressor for condensing/compressing air and an air treatment device for cleaning the air or for removing water, dirt and/or oil components from the air, which can impair the operation of the compressed air supply.

Operating data from compressed air systems have hitherto either not been transmitted at all to the user or have been transmitted only by complex sensor systems and/or wiring. It is further known in the prior art to present operating data on a fixed display, for example by an operating hours counter. This type of transmission is, on the one hand, prone to faults. On the other hand, the available data transmission volume is limited. It has therefore hitherto not been possible, for example, to capture or transmit and evaluate complex data, such as operational acceleration data on the compressor.

### SUMMARY

Disclosed embodiments make improvements in relation to the disadvantages from the prior art, in particular to provide a more reliable and flexibly usable system for providing and/or monitoring operating data of a compressed air supply, a compressed air supply, and a method for providing and/or monitoring operating data of a compressed air supply in which the data transmission capacity is increased.

### BRIEF DESCRIPTION OF THE FIGURES

Characteristics, features and advantages are explained below by a description of embodiments with reference to the attached example drawings in which:

FIG. 1 shows schematically an example embodiment of the system; and

FIG. 2 shows a flow diagram of a method according to an example embodiment.

### DETAILED DESCRIPTION

According to the disclosed embodiments, a system is provided for providing and/or monitoring operating data of a compressed air supply in a rail vehicle. Compressed air supplies serve to generate compressed air in a defined quantity and quality in order, for example, to actuate a braking system of the rail vehicle, the doors or the air suspension. The compressed air supply can comprise, for example, a compressor for condensing/compressing air, an air treatment device for cleaning the air or for removing water, dirt and oil components from the air, an air dryer, a rectifier and/or control electronics for regulating the compressed air supply. The system can, for example, provide and/or monitor operating data of one of the above components of the compressed air supply. However, it is also conceivable for the system to be assigned to further vehicle components in order to provide and/or monitor operating data of these vehicle components.

The system comprises a detector for capturing operating data. The detector can be assigned to and/or arranged on the compressed air supply in such a way that the detector is capable of capturing its operating data. The operating data to be captured can be any operating data. Compressed-air-related data, for example, such as pressure, temperature, composition particularly in relation to foreign components, such as water, dirt, engine oil, an operating state of the compressed air supply, in particular of the compressor, such as shutdown or activated state, and/or speed data and/or acceleration data of the compressor, in particular the air flowing through the compressor or the impellers of the compressor producing the compressed air can be captured. The detector can comprise, for example, a sensor system or a sensor device which is designed to capture specific physical or chemical characteristics qualitatively or quantitatively as a measured value, wherein, in particular, the operating data are captured by physical or chemical effects and are further processed and/or converted into an electrical signal. The detector can operate according to different active principles, such as mechanical, thermoelectric, resistive, piezoelectric, capacitive, inductive, optical or magnetic, depending on the operating data to be captured.

The system also comprises a communication device for wirelessly transmitting the captured operating data. The wireless transmission capability of the communication device removes the need for complex and fault-prone wiring, and allows the data transmission capacity to be increased, in particular, without restriction. In particular, acceleration data of the compressor of the compressed air supply which are to be understood as complex data and could not be communicated due to the associated high demands for the data transmission capacity by wiring can be used with the disclosed embodiments. The communication device comprises, for example, a modem or a GSM module.

The system further comprises an external storage device for receiving and storing the captured operating data from the communication device. The term “external” is to be understood to mean, in particular, that the storage device can be disposed at any local position in relation to the compressed air supply, the detector and/or the communication device, which is not the case with a data transmission by wiring.

In one example embodiment of the system, the communication device is a radio transceiver, in particular a mobile radio transceiver. The radio transceiver is capable, for example, of transmitting and receiving signals of any type by electromagnetic waves. The radio transceiver is configured, for example, to transmit and receive according to a WLAN standard or a mobile radio standard, LAN, Bluetooth, IR, etc. The standard of the IEEE-802.11 family, in particular, can be considered as a WLAN standard. This standard is characterized, in particular, by high transmit powers and ranges, and also high data transmission rates. The communication device therefore enables a bidirectional communication or data transmission, in particular with the external storage device. The return communication from the external storage device to the communication device can, for example, be a confirmation of delivery or a different acknowledgement of a data processing or data forwarding procedure.

In one example development of the system, the storage device is configured to be connected to a computing device with which the stored operating data can be processed and/or evaluated and/or forwarded. According to one example embodiment, the system comprises the computing device. The provision of the external, central storage device offers the advantage that the operating data are filed and stored in such a way that they can be made available from there to any number of subscribers or consumers or users. It is therefore possible to monitor the operation of the compressed air supply in an effective manner by the system. The captured operating data can be processed and/or evaluated so that malfunctions or critical conditions can be identified.

In one example embodiment of the system, the detector and/or the communication device is/are designed as an Internet of Things interface. The term “Internet of Things interface” refers to technologies of a global infrastructure which enables physical and virtual objects to be networked with one another and allows them to interwork by information and communication technologies. On the one hand, Internet of Things interfaces are usable independently from a complex wiring and are therefore also not tied to the maximum data transmission capacity inherent in a wiring. On the other hand, Internet of Things interfaces can provide further functions to the system, such as, for example, a processing of operating data. According to an embodiment, the communication device is or comprises the Internet of Things interface.

In one example development of the system, the Internet of Things interface is embedded into control electronics of the compressed air supply which regulate the operation of the compressed air supply. The term “embedded” can be understood to mean that the Internet of Things interface is incorporated into the technical context of the control electronics and can perform, for example, monitoring, control and/or regulating functions, or can be responsible, for example, for data or signal processing.

According to one example development of the system, the Internet of Things interface, optionally the communication device, is configured to process, in particular to filter, to compress, optionally to convert into a histogram form and/or to analyze the captured operating data, optionally using pattern recognition. An event count, for example, can be used to form histograms which can then be evaluated, in particular by pattern recognition, in order to be able to identify irregularities or irregularities in the operating data which indicate a malfunction of the compressed air supply. The term “histograms” refers to a graphical representation of a frequency distribution of cardinally scaled features. The pattern recognition makes it possible, for example, to process even less exact signals. Incorrect measured quantities, for example upward or downward outliers of the measured quantities, can be filtered out by the filtering of the received operating data in order to avoid falsifying the measurement result. As a result of this preprocessing of the captured operating data by the Internet of Things interface, the data to be transmitted to the external transmit device can be compressed and the data volume to be transmitted can be reduced overall. Only the already preprocessed, clearly presented information is transmitted to the storage device. The Internet of Things interface can be embedded accordingly into the system in such a way that the captured operating data are processed before being transmitted to the external storage device by the Internet of Things interface. In one example development of the disclosed embodiments, the Internet of Things interface can comprise a data processing component which is assigned to the detector and/or to the communication device and can process, filter, compress, convert into a histogram form and/or analyze the captured operating data.

In one example embodiment of the system, the detector and/or the communication device, in particular the Internet of Things interface, is/are configured to instigate a processing of the operating data on the basis of operating-data-specific threshold values, for example for a pressure, a temperature or the like. In particular, the detector and/or the communication device, in particular the Internet of Things interface, instigate(s) the processing of the operating data if the relevant threshold value is exceeded by the corresponding operating parameter. The Internet of Things interface can comprise, for example, a trigger logic which is triggered by specific operating data to process the operating data. The data volume to be processed can be reduced as a result. The Internet of Things interface can initiate a processing of the operating data on the basis of the operating-data-specific threshold values in order to trigger or not to trigger a transmission of the operating data to the external storage device.

According to one example development, the external storage device is implemented as a data cloud which provides storage space, computing power or application software via the Internet. A wireless transmission of the data to the storage device is thus guaranteed, and a dataless access to or retrieval of the stored data is also enabled.

In one example embodiment of the system, the external storage device and/or the computing device is/are configured to be connected to at least one mobile terminal device and/or computer interface. The system comprises, for example, at least one mobile terminal device and/or computer interface. The mobile terminal devices can, for example, be smartphones or tablets, and the computer interfaces can be local computers. The stored operating data can be accessed by the mobile terminal devices or computer interfaces. The advantage here is that the mobile terminal device or the computer interface is usable regardless of its local position and is usable with the external storage device in order to enable the wireless data transmission between the components. Only a connection by the WLAN standard or mobile radio standard is necessary.

According to one further example embodiment, reference data for a target operating state and/or an incorrect operating state of the compressed air supply are stored in the storage device and/or the computing device. The reference data can be input, for example, by a user. It is further conceivable for the reference data to be adapted or updated during the operation of the compressed air supply. It should be clear that numerous different reference data can be stored which can be assigned in each case to a specific type of operating data. The storage device and/or the computing device can be configured to compare the reference data with the received operating data. Database operators, for example, can be used.

According to one example development of the system, the storage device and/or the computing device is/are further configured to recognize a target operating state or an incorrect operating state of the compressed air supply on the basis of the comparison of the reference data and the received operating data. The computing device and/or the storage device is/are therefore also able to identify, in particular to quantify, a deviation of the received operating data from the reference data in order to be able to quickly establish the extent of the deviation, as a result of which, for example, a critical operating state can be identified in the case of a significant deviation between the target state and the actual state.

In particular, the system is configured in such a way that no access to the compressed air supply and its components, i.e., no influencing of the operation of the compressed air supply, is possible from outside, for example by the external storage device and/or the computing device and/or a mobile terminal device and/or a computer interface. This absence of repercussions can be an important criterion, in particular for preventing possibly uncontrolled external access to the compressed air supply. According to one example development, the system is configured so that it can be modified in such a way that, in the case of an incorrect operating state of the compressed air supply, wireless intervention in the operation of the compressed air supply can be performed, in particular the operation of the compressed air supply can be stopped and/or the compressed air supply can be switched to emergency operation. It can be provided, for example, that external access to the compressed air supply is linked to an authentication in order to exclude unauthorized access. Critical operating states, for example, can thereby be circumvented or averted. Maintenance measures can further be initiated in order to restore the functionality of the compressed air supply. It is further conceivable for empirical values to be collected from the captured operating data, on the basis of which maintenance intervals and maintenance measures can be more effectively planned and established. The operation of the compressed air supply can, for example, also be optimized. Due to the monitoring of the operating data and, in particular, the comparison with reference data, it is also possible to respond to the wearing of the components of the compressed air supply resulting from the operation of the compressed air supply. A further advantage of the wireless transmission is that, in the case of the modified system according to which external access to the compressed air supply is permitted, if an incorrect operating state has been identified, wireless access to the operation of the compressed air supply is possible, particularly in order to stop or restrict operation. Access to the operation of the compressed air supply is thus possible regardless of the respective position of the user or the control system which can be stored, for example, on the external storage unit, the computing device or a mobile terminal device or computer interface.

According to a further aspect of the disclosed embodiments, a compressed air supply is provided to generate compressed air for a rail vehicle. Compressed air supplies serve to generate compressed air in a defined quantity and quality in order, for example, to actuate a braking system of the rail vehicle, the doors or the air suspension. The compressed air supply can comprise, for example, a compressor for condensing/compressing air, an air treatment device for cleaning the air or for removing water, dirt and oil components from the air, an air dryer, a rectifier and/or control electronics for regulating the compressed air supply. The compressed air supply further comprises a system for providing and/or monitoring operating data. In one example embodiment of the compressed air supply, the system is designed to provide and/or monitor operating data according to one of the aspects or embodiments described above.

According to a further aspect of the disclosed embodiments which is combinable with the previously described aspects, a method is provided for providing operating data and/or for monitoring the functionality of a compressed air supply in a rail vehicle. The operating data of the compressed air supply are captured accordingly. The operating data can be captured automatically and periodically at fixed time intervals. The captured operating data are further transmitted wirelessly to an external storage device. The operating data are further received and stored by the external storage device. It should be clear that the corresponding components can be designed in the manner described with reference to the system according to the disclosed embodiment and/or the compressed air supply according to the disclosed embodiments.

According to one example development of the method, the method is configured to implement the system according to one of the previously described aspects or example embodiments and/or the compressed air supply according to one of the previously described aspects.

The disclosed embodiments further provide a computer-readable data medium on which instructions are stored which, when they are executed by a computing device, carry out the method for providing operating data and/or for monitoring the functionality of a compressed air supply in a rail vehicle.

In the following description of example embodiments, a system for providing and/or monitoring operating data of a compressed air supply which is indicated by the reference number 3 in a rail vehicle 5 is denoted by the reference number 1.

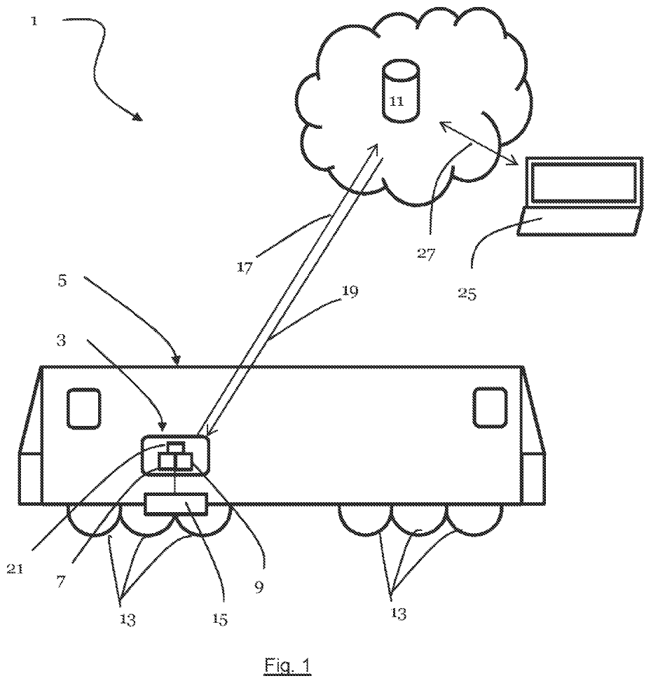

FIG. 1 shows schematically a rail vehicle 5 having wheels 13 and a braking system 15 assigned to at least one wheel 13. The braking system 15 is actuated, in particular, by a compressed air supply 3 which can generate compressed air in a specific quality and quantity, for example in order to actuate the braking system 15, i.e., to bring brake shoes of the braking system 15 into frictional contact with brake discs of the wheels 13. The system 1 comprises a detector 7 for capturing the operating data of the compressed air supply 3 of the rail vehicle 5, wherein it is also conceivable for it to be assigned to further vehicle components (not shown). The detector 7 can be configured to capture the operating data of the compressed air supply 3 or of individual components thereof. A compressed air supply 3 can comprise, for example, a compressor for condensing/compressing air, an air treatment device for cleaning the air or for removing water, dirt and oil components from the air, an air dryer, a rectifier and/or control electronics for regulating the compressed air supply 3. The disclosed embodiments are not limited to a specific component. The operating data to be captured can be any operating data. The operating data may, for example, be compressed-air-related data, such as pressure, temperature, composition particularly in relation to foreign components, such as water, dirt, engine oil, an operating state of the compressed air supply 3, in particular of the compressor, such as shutdown or activated state, and/or speed data and/or acceleration data of the compressor, in particular the air flowing through the compressor or the impellers of the compressor producing the compressed air. It should be clear that the respective detector 7 is designed and/or arranged in such a way that it can capture the respective operating data. The detector 7 can have, for example, a data processing unit, such as, for example, a microprocessor, with which the captured data can be processed, and also a local memory in which the data can be stored.

The detector 7 is connected to a communication device 9 with which the captured or stored operating data can be transmitted wirelessly, for example on the basis of a WLAN standard or mobile radio standard, and can be transmitted, for example, to an external storage device. As a result, complex and fault-prone wiring is no longer required. The wireless transmission path further allows data volumes of any size to be communicated. The communication device 9 is connected, for example, to the external data storage device 11, such as, for example, a cloud. The operating data can be captured and/or transmitted to the external data storage device 11 automatically and according to a predefined schedule, indicated in FIG. 1 by the arrow with the reference number 17. The process of capturing and/or transmitting the operating data can also be triggered by measurement parameters, such as, for example, temperature, pressure, time duration, etc. In particular, the detector 7 and/or the communication device 9 is/are configured to instigate a processing of the operating data on the basis of operating-data-specific threshold values which are stored, for example, in the respective data processing unit or the respective storage device.

The external storage device 11 can be connected to a computing device 25 which is designed to process and/or evaluate and/or forward the received and stored operating data. The connection/communication between the storage device 11 and the computing device 25 is indicated schematically by the arrow with the reference number 27. It is thereby possible, for example, to identify critical operating states of the compressed air supply 3. If necessary, maintenance measures can then be instigated and/or the operation of the compressed air supply 3 can be stopped or restricted. It is further conceivable to collect empirical values from the captured operating data, on the basis of which maintenance intervals and maintenance measures can be more effectively planned and established. The provision of the data in an external data device 11 and/or in a computing device 25 further proves to be advantageous insofar as the external storage device 11 and/or the computing device 25 can further be configured to be connected to at least one, optionally a plurality of mobile terminal devices (not shown) and/or computer interfaces (not shown), such as local computers, so that the data can be accessed by the mobile terminal devices or computer interfaces. The mobile terminal device or computer interface is usable irrespective of the local position and is usable with the external storage device 11, wherein only a connection by the WLAN standard or mobile radio standard must be provided. A return communication from the external storage device 11 to the communication device 9, for example an acknowledgement of receipt of operating data or alternatively access of the external storage device 11 and/or the computing device 25 or a mobile terminal device to the operation of the compressed air supply 3, is indicated by the arrow with the reference number 19. Damage to the components of the compressed air supply 3 can in turn be avoided since action can be taken wirelessly with regard to the compressed air supply 3, in particular its operation can be switched to an emergency running mode or can be stopped.

The detector 7 and/or the communication device 9 can be designed as an Internet of Things interface which is indicated schematically by the reference number 21. The Internet of Things interface 21 can be embedded into control electronics (not shown) of the compressed air supply 3. The Internet of Things interface 21 can be designed to preprocess the operating data captured by the detector 7, i.e., to process them before they are transmitted to the external storage device 11. The Internet of Things interface 21 can be configured, for example, to filter and/or to compress and/or to analyze the captured operating data. An event count, for example, can be used for this purpose to form histograms which can then be evaluated, in particular by pattern recognition, in order to be able to identify regularities or irregularities in the operating data which can indicate a malfunction of the compressed air supply 3.

The detector 7 and/or the communication device 9 or the Internet of Things interface 21 can be configured to instigate a processing of the operating data on the basis of operating-data-specific threshold values, for example for a pressure, a temperature or the like. The Internet of Things interface 21 can comprise, for example, a trigger logic (not shown) which is triggered by specific operating data to process the operating data. The Internet of Things interface 21 can initiate a processing of the operating data on the basis of the operating-data-specific threshold values in order to trigger or not trigger a transmission of the operating data to the external storage device 11.

Reference data for a target operating state and/or incorrect operating state of the compressed air supply can further be stored for the system 1, for example on the storage device 11 and/or the computing device 25. The reference data can, for example, be input by a user. It is further conceivable for the reference data to be adapted or updated during the operation of the compressed air supply 3. It should be clear that numerous different reference data can be stored which can be assigned in each case to a specific type of operating data. The storage device 11 and/or the computing device 25 can be configured to compare the reference data with the received operating data. Database operators, for example, can be used.

A target operating state or incorrect operating state of the compressed air supply 3 can be identified on the basis of the comparison of the reference data and the received operating data. The computing device 25 and/or the storage device 11 is/are therefore also able to identify, in particular to quantify, a deviation of the received operating data from the reference data in order to be able to quickly establish the extent of the deviation, as a result of which, for example, a critical operating state can be identified in the case of a significant deviation between the target state and the actual state.

The system 1 is normally configured in such a way that no external access to the compressed air supply 3 and its components is possible. However, the system 1 can be modified in such a way that, in the case of an incorrect operating state of the compressed air supply 3, action can be taken wirelessly with regard to the operation of the compressed air supply 3, in particular the operation of the compressed air supply 3 can be stopped and/or the compressed air supply 3 can be switched to emergency operation. Empirical values can further be collected from the captured operating data, on the basis of which maintenance intervals and maintenance measures can be more effectively planned and established. The operation of the compressed air supply 3 can, for example, also be optimized. Due to the monitoring of the operating data and, in particular, the comparison with reference data, it is also possible to respond to the wearing of the components of the compressed air supply 3 resulting from the operation of the compressed air supply 3. According to the modified system 1, access to the operation of the compressed air supply 3 is possible regardless of the respective position of the user or the control system which can be stored, for example, on the external storage unit 11, the computing device 25 or a mobile terminal device or computer interface.

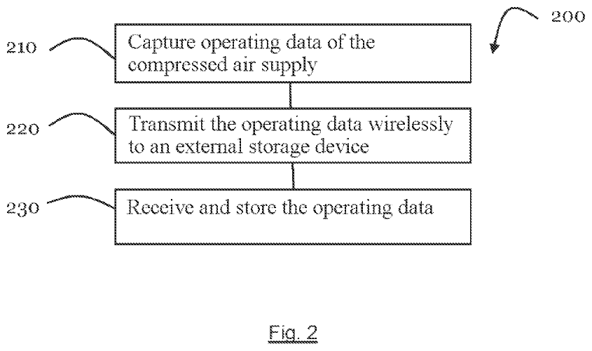

The flow diagram according to FIG. 2 shows an example embodiment of a method which is denoted in general with the reference number 200 for providing operating data and/or for monitoring the functionality of a compressed air supply 3 in a rail vehicle 5. According to a method operation 210, the operating data of the compressed air supply 3 are captured. The capture can be carried out automatically and periodically at fixed time intervals. According to a method operation 220, the captured operating data are transmitted wirelessly to an external storage device 11. According to a method operation 230, the operating data are further received and stored by the external storage device 11. It should be clear that the corresponding components can be designed in the manner described with reference to the system 1 and/or the compressed air supply 3.

According to one example development of the method 200, the method is configured to implement the system 1 according to one of the embodiments and/or the compressed air supply 3 according to one of the previously described aspects by corresponding method operations.

The features disclosed in the above description, the figures and the claims can be of importance both individually and in any combination for the implementation in the different embodiments.

### REFERENCE NUMBER LIST

1 System
3 Compressed air supply
5 Rail vehicle
7 Detector
9 Communication device
11 Storage device
13 Wheel
15 Braking system
17, 19 Data exchange
21 Internet of Things
25 Computing device
27 Data exchange
200 Method
210 Method operation
220 Method operation
230 Method operation

1. A system for providing and/or monitoring operating data of a compressed air supply in a rail vehicle, the system comprising:
a detector for capturing the operating data;
a communication device for wirelessly transmitting the captured operating data; and
an external storage device for receiving and storing the captured operating data from the communication device.

2. The system of claim 1, wherein the communication device is a mobile radio transceiver configured to transmit and receive according to a mobile radio standard or WLAN standard.

3. The system of claim 1, wherein the storage device is configured to be connected to a computing device with which the stored operating data is processed and/or evaluated and/or forwarded.

4. The system of claim 1, wherein the detector and/or the communication device is/are an Internet of Things interface.

5. The system of claim 4, wherein the Internet of Things interface is embedded into control electronics of the compressed air supply.

6. The system of claim 4, wherein the Internet of Things interface is configured to filter, to compress, to convert into a histogram form and/or to analyze the captured operating data.

7. The system of claim 1, wherein the detector and/or the communication device is/are configured to instigate a processing of the operating data based on operating-data-specific threshold values.

8. The system of claim 1, wherein the external storage device is implemented as a data cloud.

9. The system of claim 1, wherein the external storage device and/or the computing device is/are configured to be connected to at least one mobile terminal device and/or computer interface.

10. The system of claim 1, wherein reference data for a target operating state and/or an incorrect operating state of the compressed air supply are stored in the storage device and/or the computing device and/or the communication device, and wherein the storage device and/or the computing device and/or the communication device is/are configured to compare the reference data with the received operating data.

11. The system of claim 10, wherein the storage device and/or the computing device and/or the communication device is/are further configured to identify a target operating state or incorrect operating state of the compressed air supply based on the comparison of the reference data and the received operating data.

12. A compressed air supply for generating compressed air for a rail vehicle, the compressed air supply comprising a system as recited in claim 1 for providing and/or monitoring operating data of the compressed air supply.

13. A method for providing operating data and/or for monitoring the functionality of a compressed air supply in a rail vehicle, the method comprising:
capturing operating data of the compressed air supply;
transmitting the captured operating data wirelessly to an external storage device; and
receiving and storing the captured operating data for subsequent processing, evaluation and/or forwarding by the external storage device.

14. (canceled)

15. The system of claim 6, wherein the Internet of Things interface is configured to analyze the captured operated data using pattern recognition.

16. The method of claim 13, further comprising processing, evaluating and/or forwarding the stored captured operating data.

17. The method of claim 13, wherein the wireless transmission is performed according to a mobile radio standard or WLAN standard.

18. The method of claim 13, further comprising filtering, compressing, analyzing and/or converting the captured operating data into a histogram form.

19. The method of claim 13, further comprising instigating a processing of the operating data based on operating-data-specific threshold values.

20. The method of claim 13, further comprising storing reference data for a target operating state and/or an incorrect operating state of the compressed air supply in a storage device and comparing the reference data to the received operating data.

21. The method of claim 20, further comprising identifying a target operating state or incorrect operating state of the compressed air supply based on the comparison of the reference data and the received operating data.
